(19) United States
(12) Patent Application Publication
(10) Pub. No.: US 2021/0383036 A1
(43) Pub. Date: Dec. 9, 2021

(54) AGRICULTURAL WATER-SAVING PLANNING METHOD BASED ON REMOTELY-SENSED EVAPOTRANSPIRATION

(71) Applicant: China Institute of Water Resources and Hydropower Research, Beijing (CN)

(72) Inventors: Bo LEI, Beijing (CN); Lijuan DU, Beijing (CN); Baozhong ZHANG, Beijing (CN); Yang LIU, Beijing (CN); Changshun LIU, Beijing (CN); Kaijing YANG, Beijing (CN); Bei WANG, Beijing (CN)

(73) Assignee: China Institute of Water Resources and Hydropower Research, Beijing (CN)

(21) Appl. No.: 17/338,713

(22) Filed: Jun. 4, 2021

(30) Foreign Application Priority Data
Jun. 9, 2020 (CN) 202010516883.7

(51) Int. Cl. G06F 30/20; G06Q 50/02; G06Q 50/26; G06Q 10/06; G06Q 50/06; G06Q 30/00

(52) U.S. Cl. CPC G06F 30/20; G06Q 50/02; G06Q 50/26; G06F 2111/10; G06Q 50/06; G06Q 30/018; G06Q 10/06313

(57) ABSTRACT

An agricultural water-saving planning method based on a remotely-sensed ET includes the following steps: S1: determining an agricultural target ET of a crop; S2: establishing an agricultural water-saving planning model based on the agricultural target ET of the crop, and planning a planting area of the crop of a whole county to obtain a county-level planning scheme; and S3: decomposing the county-level planning scheme to township-level governments and further to village-level units for execution and supervision. The new method realizes the balance between real regional agricultural water consumption and actual water supply.

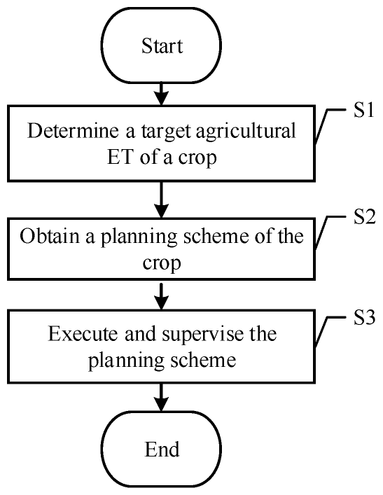

### CROSS REFERENCE TO THE RELATED APPLICATIONS

This application is based upon and claims priority to Chinese Patent Application No. 202010516883.7, filed on Jun. 9, 2020, the entire contents of which are incorporated herein by reference.

### TECHNICAL FIELD

The present invention relates to the technical field of monitoring for remotely-sensed evapotranspiration (ET), and more particularly, to an agricultural water-saving planning method based on a remotely-sensed ET.

### BACKGROUND

An analysis method used in traditional agricultural water-saving development and planning can basically reflect a current situation and a trend of regional agricultural water, and can also provide powerful guidance for local agricultural development. From the perspective of water consumption, however, some problems still exist: (1) The estimation of an available water amount is uncertain. (2) There is little to no consideration of water reuse among different water use industries and units. (3) The utilization coefficient of irrigation water is used as an important basis to evaluate water saving, which does not take the water reuse into account and thus may overestimate a water-saving potential. (4) It is impossible to evaluate whether a hydrologic budget is really reached in a region from the perspective of supply and consumption. (5) The traditional agricultural water-saving potential is a water intake reduced for engineering, and is realized by increasing the utilization coefficient of the irrigation water and reducing a capillary quota. This may exaggerate the agricultural water-saving potential. (6) The traditional estimation method for an agricultural water demand overestimates an effect of water saving of engineering, and cannot accurately estimate an actual agricultural water demand. Moreover, because the difference between the use of return flow of the irrigation water and the non-agricultural water consumption is confused, actual water consumption of other industries may be underestimated.

### SUMMARY

In view of the above shortcomings in the prior art, the present invention provides an agricultural water-saving planning method based on a remotely-sensed ET, which realizes the balance between real regional agricultural water consumption and actual water supply.

To achieve the above objective, the present invention adopts the following technical solutions. An agricultural water-saving planning method based on a remotely-sensed ET includes the following steps:

S1: determining an agricultural target ET of a crop;

S2: establishing an agricultural water-saving planning model based on the agricultural target ET of the crop, and planning a planting area of the crop of a whole county to obtain a county-level planning scheme; and

S3: decomposing the county-level planning scheme to township-level governments and further to village-level units for execution and supervision.

Further, a method for determining the agricultural target ET of the crop in step S1 includes:

S11: calculating a regional usable water consumption according to supply-consumption balance of a water resource;

S12: calculating a productive water consumption according to the regional usable water consumption; and

S13: obtaining the agricultural target ET by deducting a domestic water consumption and an industrial water consumption from the productive water consumption.

Further, a formula for calculating the regional usable water consumption in step S11 is as follows:

ET_{Regional}=R+P−O−CS (1),

wherein, ET_{Regional} represents the regional usable water consumption; R represents an inflow amount; P represents an effective precipitation; O represents an outflow amount; and CS represents a change amount of a groundwater reserve.

Further, formulas for calculating the productive water consumption in step S12 are as follows:

ET_{Productive}=ET_{Regional}−ET_{Non-productive} (2),

ET_{Non-productive}=ET_{Forest}+ET_{Grassland}+ET_{Water body}+ET_{Farmland}+ET_{Urban}+ET_{Nudation} (3),

wherein, ET_{Productive} represents the productive water consumption; ET_{Non-productive} represents a non-productive water consumption; ET_{Forest} represents a forest-specific water consumption; ET_{Grassland} represents a grassland-specific water consumption; ET_{water body} represents a water body-specific water consumption; ET_{Farmland} represents a farmland-specific water consumption; ET_{Urban} represents an urban water consumption; and ET_{Nudation} represents a nudation-specific water consumption.

Further, the forest-specific water consumption ET_{Forest}, the grassland-specific water consumption ET_{Grassland}, the water body-specific water consumption ET_{water body}, and the nudation-specific water consumption ET_{Nudation} are calculated by superimposing the remotely-sensed ET and land use data.

A method for calculating the non-productive farmland-specific water consumption ET_{Farmland} includes:

A1: extracting a regional unplanted farmland by using an extraction and recognition method of an unplanted farmland, and superimposing data of the unplanted farmland and data of the remotely-sensed ET to obtain ET data of the unplanted farmland; and

A2: calculating the non-productive farmland-specific water consumption ET_{Farmland} of a planted farmland by using a geostatistical spatial interpolation method based on the ET data of the unplanted farmland.

Further, a formula for calculating the agricultural target ET in step S13 is as follows:

ET_{Target}=ET_{Productive}−ET_{Domestic}−ET_{Industrial} (4),

wherein, ET_{Target}represents the agricultural target ET, ET_{Domestic} represents the productive domestic water consumption, and ET_{Industrial} represents the productive industrial water consumption.

Further, the agricultural water-saving planning model in step S2 is as follows:

maxΣᵢBᵢ(Q_{ETi}, Aᵢ) (5),

ET_{Target}≥Σᵢ₌₁ⁿAᵢ*et_{q}ⁱ (6),

ΣᵢAᵢ≤A (7),

wherein, i represents a type of a planted crop; Aᵢ represents a planting area of the crop i; Q_{ETi} represents a water use efficiency of the crop i; et_{q}ⁱ represents a recommended water consumption quota of the crop i; A represents a total area of a regional available farmland, Bᵢ represents a yield of the crop i; and n represents a quantity of types of regionally planted crops.

The above solutions have an advantage that the yield of the crop is maximized under the water consumption constraint and the farmland constraint.

Further, step S3 includes the following steps:

S31: refining the county-level planning scheme and the agricultural target ET to the village-level units to obtain a target red line of a village-level water consumption, a planned planting structure, and a planned planting scale for each crop by year;

S32: taking the target red line of the village-level water consumption as a basic constraint for monitoring a water consumption, and performing an inversion on remotely-sensed data having a precision of 5 m to obtain the remotely-sensed ET to further obtain an annual actual village-level water consumption;

S33: determining whether the annual actual village-level water consumption is within the target red line of the village-level water consumption; if the annual actual village-level water consumption is within the target red line of the village-level water consumption, determining that the water consumption of the crop is in a safe range in a planning year, and ending a process; if the annual actual village-level water consumption is not within the target red line of the village-level water consumption, performing step S34;

S34: directly matching data of the remotely-sensed ET having the precision of 5 m with cadastral data to obtain water consumption data of the crop and a planting scale of the crop which exceed the target red line of the village-level water consumption;

S35: obtaining an actual per-mu water consumption of the crop according to the water consumption data of the crop and the planting scale of the crop which exceed the target red line of the village-level water consumption;

S36: determining whether the actual per-mu water consumption exceeds a recommended water consumption quota of the crop; if the actual per-mu water consumption exceeds the recommended water consumption quota of the crop, supplying water based on the recommended water consumption quota of the crop in a next year, and performing step S37; if the actual per-mu water consumption does not exceed the recommended water consumption quota of the crop, performing step S37; and

S37: determining whether the planting scale of the crop exceeds the planned planting scale of the planning year; if the planting scale of the crop exceeds the planned planting scale of the planning year, planting the crop in the next year according to the planned planting structure and the planned planting scale of the planning year; if the planting scale of the crop does not exceed the planned planting scale of the planning year, ending the process.

In conclusion, the present invention has the following advantages.

(1) Based on the supply-consumption balance of the water resource, in the present invention, balance of agricultural water resources is analyzed, a real water-saving potential of the agricultural water is estimated, evaluation and optimization are performed, and regional agricultural water balance is really evaluated from the perspective of water consumption. This has significant advantages for optimal allocation of the agricultural water resources and realization of real resource-based water saving.

(2) Based on the supply-consumption balance of the water resource, a change law of regional water consumption is analyzed from the perspective of regional space. This is helpful to find a regional water consumption law in terms of space, and makes it possible to use a region with abundant water to make up for a region that lacks water in terms of space in a process of formulating an agricultural development and planning scheme.

(3) A change in the regional usable water consumption is monitored by monitoring the ET through remote sensing. In this way, actual regional water consumption can be accurately monitored.

(4) By means of the agricultural water-saving planning model, when the farmland area is limited and water consumption of all crops in the region is limited based on water consumption of each crop, the crop yield is maximized.

### BRIEF DESCRIPTION OF THE DRAWINGS

FIGURE is a flowchart of an agricultural water-saving planning method based on a remotely-sensed ET.

### DETAILED DESCRIPTION OF THE EMBODIMENTS

Embodiments of the present invention are described in detail below to facilitate those skilled in the art to understand the present invention, but it should be noted that the present invention is not limited to the scope of the embodiments. For those skilled in the art, as long as various changes are within the spirit and scope, limited and determined by the appended claims, of the present invention, these changes are obvious, and all inventions and innovations using the concept of the present invention shall fall within the scope of protection of the present invention.

As shown in FIGURE, an agricultural water-saving planning method based on a remotely-sensed ET includes the following steps:

S1: an agricultural target ET of a crop is determined.

A method for determining the agricultural target ET of the crop in step S1 includes:

S11: a regional usable water consumption is calculated according to supply-consumption balance of a water resource.

A formula for calculating the regional usable water consumption in step S11 is as follows:

ET_{Regional}=R+P−O−CS (1),

where, ET_{Regional} represents the regional usable water consumption; R represents an inflow amount; P represents an effective precipitation; O represents an outflow amount; and CS represents a change amount of a groundwater reserve.

S12: a productive water consumption is calculated according to the regional usable water consumption.

Formulas for calculating the productive water consumption in step S12 are as follows:

ET_{Productive}=ET_{Regional}−ET_{Non-productive} (2),

ET_{Non-productive}=ET_{Forest}+ET_{Grassland}+ET_{Water body}+ET_{Farmland}+ET_{Urban}+ET_{Nudation} (3),

where, ET_{Productive} represents the productive water consumption; ET_{Non-productive} represents a non-productive water consumption; ET_{Forest} represents a forest-specific water consumption; ET_{Grassland} represents a grassland-specific water consumption; ET_{water body} represents a water body-specific water consumption; ET_{Farmland} represents a farmland-specific water consumption; ET_{Urban} represents an urban water consumption; and ET_{Nudation} represents a nudation-specific water consumption.

The forest-specific water consumption ET_{Forest}, the grassland-specific water consumption ET_{Grassland}, the water body-specific water consumption ET_{water body}, and the nudation-specific water consumption ET_{Nudation} are calculated by superimposing the remotely-sensed ET and the land use data.

A method for calculating the non-productive farmland-specific water consumption ET_{Farmland} includes:

A1: a regional unplanted farmland is extracted by using an extraction and recognition method of an unplanted farmland, and data of the unplanted farmland and data of the remotely-sensed ET are superimposed to obtain ET data of the unplanted farmland.

A2: the non-productive farmland-specific water consumption ET_{Farmland} of a planted farmland is calculated by using a geostatistical spatial interpolation method based on the ET data of the unplanted farmland.

S13: the agricultural target ET is obtained by deducting a domestic water consumption and an industrial water consumption from the productive water consumption.

A formula for calculating the agricultural target ET in step S13 is as follows:

ET_{Target}=ET_{Productive}−ET_{Domestic}−ET_{Industrial} (4),

where, ET_{Target} represents the agricultural target ET; ET_{Domestic} represents the productive domestic water consumption, and ET_{Industrial} represents the productive industrial water consumption.

S2: an agricultural water-saving planning model is established based on the agricultural target ET of the crop, and a planting area of the crop of a whole county is planned to obtain a county-level planning scheme.

The agricultural water-saving planning model in step S2 is as follows:

maxΣᵢBᵢ(Q_{ETi}, Aᵢ) (5),

ET_{Target}≥Σᵢ₌₁ⁿAᵢ*et_{q}ⁱ (6),

ΣᵢAᵢ≤A (7),

where, i represents a type of a planted crop; Aᵢ represents a planting area of the crop i; Q_{ETi} represents a water use efficiency of the crop i; et_{q}ⁱ represents a recommended water consumption quota for the crop i; A represents a total area of a regional available farmland; Bᵢ represents a yield of the crop i; and n represents a quantity of types of regionally planted crops. The formula (6) and the formula (7) are constraints of the formula (5).

The agricultural water-saving planning model maximizes the yield of the crop under the water consumption constraint and the farmland constraint.

A red line of a agricultural water consumption is equal to Σᵢ₌₁ⁿAᵢ*et_{q}ⁱ.

S3: the county-level planning scheme is decomposed to township-level governments and further to village-level units for execution and supervision.

Step S3 includes the following substeps:

S31: the county-level planning scheme and the agricultural target ET are refined to the village-level units to obtain a target red line of a village-level water consumption, a planned planting structure, and a planned planting scale for each crop by year.

S32: the target red line of the village-level water consumption is taken as a basic constraint for monitoring a water consumption, and inversion is performed on remotely-sensed data having a precision of 5 m to obtain the remotely-sensed ET to further obtain an annual actual village-level water consumption.

S33: it is determined whether the annual actual village-level water consumption is within the target red line of the village-level water consumption. Specifically, if the annual actual village-level water consumption is within the target red line of the village-level water consumption, it is determined that the water consumption of the crop is in a safe range in a planning year, and the process is ended. If the annual actual village-level water consumption is not within the target red line of the village-level water consumption, step S34 is performed.

S34: data of the remotely-sensed ET having the precision of 5 m is directly matched with cadastral data to obtain water consumption data of the crop and a planting scale of the crop which exceed the target red line of the village-level water consumption.

S35: an actual per-mu water consumption of the crop is obtained according to the water consumption data of the crop and the planting scale of the crop which exceed the target red line of the village-level water consumption.

S36: it is determined whether the actual per-mu water consumption exceeds a recommended water consumption quota of the crop. Specifically, if the actual per-mu water consumption exceeds the recommended water consumption quota of the crop, water is supplied based on the recommended water consumption quota of the crop in a next year, and step S37 is performed. If the actual per-mu water consumption does not exceed the recommended water consumption quota of the crop, step S37 is performed.

S37: it is determined whether the planting scale of the crop exceeds the planned planting scale of the planning year. Specifically, if the planting scale of the crop exceeds the planned planting scale of the planning year, the crop is planted in the next year according to the planned planting structure and the planned planting scale of the planning year. If the planting scale of the crop does not exceed the planned planting scale of the planning year, the process is ended.

In conclusion, the present invention has the following advantages:

(1) Based on the supply-consumption balance of the water resource, in the present invention, balance of agricultural water resources is analyzed, a real water-saving potential of the agricultural water is estimated, evaluation and optimization are performed, and regional agricultural water balance is really evaluated from the perspective of water consumption. This has significant advantages for optimal allocation of the agricultural water resources and realization of real resource-based water saving.

(2) Based on the supply-consumption balance of the water resource, a change law of regional water consumption is analyzed from the perspective of regional space. This is helpful to find a regional water consumption law in terms of space, and makes it possible to use a region with abundant water to make up for a region that lacks water in terms of space in a process of formulating an agricultural development and planning scheme.

(3) A change in the regional usable water consumption is monitored by monitoring the ET through remote sensing. In this way, actual regional water consumption can be accurately monitored.

(4) By means of the agricultural water-saving planning model, when the farmland area is limited and water consumption of all crops in the region is limited based on water consumption of each crop, the crop yield is maximized.

What is claimed is:

1. An agricultural water-saving planning method based on a remotely-sensed evapotranspiration (ET), comprising the following steps:
S1: determining an agricultural target ET of a crop;
S2: establishing an agricultural water-saving planning model based on the agricultural target ET of the crop, and planning a planting area of the crop of a whole county to obtain a county-level planning scheme; and
S3: decomposing the county-level planning scheme to township-level governments and further to village-level units for execution and supervision.

2. The agricultural water-saving planning method based on the remotely-sensed ET according to claim 1, wherein
a method for determining the agricultural target ET of the crop in step S1 comprises:
S11: calculating a regional usable water consumption according to a supply-consumption balance of a water resource;
S12: calculating a productive water consumption according to the regional usable water consumption; and
S13: obtaining the agricultural target ET by deducting a productive domestic water consumption and a productive industrial water consumption from the productive water consumption.

3. The agricultural water-saving planning method based on the remotely-sensed ET according to claim 2, wherein
a formula for calculating the regional usable water consumption in step S11 is as follows:
ET_{Regional}=R+P−O−CS (1),
wherein, ET_{Regional} represents the regional usable water consumption; R represents an inflow amount; P represents an effective precipitation; O represents an outflow amount; and CS represents a change amount of a groundwater reserve.

4. The agricultural water-saving planning method based on the remotely-sensed ET according to claim 3, wherein
formulas for calculating the productive water consumption in step S12 are as follows:
ET_{Productive}=ET_{Regional}−ET_{Non-productive} (2),
ET_{Non-productive}=ET_{Forest}+ET_{Grassland}+ET_{Water body}+ET_{Farmland}+ET_{Urban}+ET_{Nudation} (3),
wherein, ET_{Productive} represents the productive water consumption; ET_{Non-productive} represents a non-productive water consumption; ET_{Forest} represents a forest-specific water consumption; ET_{Grassland} represents a grassland-specific water consumption; ET_{water body} represents a water body-specific water consumption; ET_{Farmland} represents a non-productive farmland-specific water consumption; ET_{Urban} represents an urban water consumption; and ET_{Nudation} represents a nudation-specific water consumption.

5. The agricultural water-saving planning method based on the remotely-sensed ET according to claim 4, wherein
the forest-specific water consumption ET_{Forest}, the grassland-specific water consumption ET_{Grassland}, the water body-specific water consumption ET_{water body}, and the nudation-specific water consumption ET_{Nudation} are calculated by superimposing the remotely-sensed ET and land use data; and
a method for calculating the non-productive farmland-specific water consumption ET_{Farmland} comprises:
A1: extracting a regional unplanted farmland by using an extraction and recognition method of an unplanted farmland, and superimposing data of the regional unplanted farmland and data of the remotely-sensed ET to obtain ET data of the regional unplanted farmland; and
A2: calculating the non-productive farmland-specific water consumption ET_{Farmland} of a planted farmland by using a geostatistical spatial interpolation method based on the ET data of the regional unplanted farmland.

6. The agricultural water-saving planning method based on the remotely-sensed ET according to claim 4, wherein
a formula for calculating the agricultural target ET in step S13 is as follows:
ET_{Target}=ET_{Productive}−ET_{Domestic}−ET_{Industrial} (4),
wherein, ET_{Target} represents the agricultural target ET, ET_{Domestic} represents the productive domestic water consumption, and ET_{Industrial} represents the productive industrial water consumption.

7. The agricultural water-saving planning method based on the remotely-sensed ET according to claim 1, wherein
the agricultural water-saving planning model in step S2 is as follows:
maxΣᵢBᵢ(Q_{ETi}, Aᵢ) (5),
ET_{Target}≥Σᵢ₌₁ⁿAᵢ*et_{q}ⁱ (6),
ΣᵢAᵢ≤A (7),
wherein, i represents a type of a planted crop; Aᵢ represents a planting area of the planted crop i; Q_{ETi} represents a water use efficiency of the planted crop i; et_{q}ⁱ represents a recommended water consumption quota of the planted crop i; A represents a total area of a regional available farmland, Bᵢ represents a yield of the planted crop i; and n represents a quantity of types of regionally planted crops.

8. The agricultural water-saving planning method based on the remotely-sensed ET according to claim 1, wherein
step S3 comprises the following substeps:
S31: refining the county-level planning scheme and the agricultural target ET to the village-level units to obtain a target red line of a village-level water consumption, a planned planting structure, and a planned planting scale for each crop by year;
S32: taking the target red line of the village-level water consumption as a basic constraint for monitoring a water consumption, and performing an inversion on remotely-sensed data having a precision of 5 m to obtain the remotely-sensed ET to further obtain an annual actual village-level water consumption;
S33: determining whether the annual actual village-level water consumption is within the target red line of the village-level water consumption; when the annual actual village-level water consumption is within the target red line of the village-level water consumption, determining that the water consumption of the crop is in a safe range in a planning year, and ending a process; when the annual actual village-level water consumption is not within the target red line of the village-level water consumption, performing step S34;
S34: directly matching data of the remotely-sensed ET having the precision of 5 m with cadastral data to obtain water consumption data of the crop and a planting scale of the crop, wherein the water consumption data of the crop and the planting scale of the crop exceed the target red line of the village-level water consumption;
S35: obtaining an actual per-mu water consumption of the crop according to the water consumption data of the crop and the planting scale of the crop, wherein the water consumption data of the crop and the planting scale of the crop exceed the target red line of the village-level water consumption;
S36: determining whether the actual per-mu water consumption exceeds a recommended water consumption quota of the crop; when the actual per-mu water consumption exceeds the recommended water consumption quota of the crop, supplying water based on the recommended water consumption quota of the crop in a next year, and performing step S37;
when the actual per-mu water consumption does not exceed the recommended water consumption quota of the crop, performing step S37; and
S37: determining whether the planting scale of the crop exceeds the planned planting scale of the planning year; when the planting scale of the crop exceeds the planned planting scale of the planning year, planting the crop in the next year according to the planned planting structure and the planned planting scale of the planning year; when the planting scale of the crop does not exceed the planned planting scale of the planning year, ending the process.
